(19) United States
(12) Patent Application Publication
(10) Pub. No.: US 2019/0261571 A1
(43) Pub. Date: Aug. 29, 2019

(54) GRAIN BEATER ACCELERATOR CYLINDER TO HARVESTER

(71) Applicant: Vanderlei Kamphorst, Horizontina (BR)

(72) Inventor: Vanderlei Kamphorst, Horizontina (BR)

(21) Appl. No.: 15/905,927

(22) Filed: Feb. 27, 2018

(51) Int. Cl. A01F 12/20; A01F 7/06

(52) U.S. Cl. CPC A01F 12/20; A01F 7/06

(57) ABSTRACT

GRAIN BEATER ACCELERATOR CYLINDER TO HARVESTERS provided with multiple paddles in a shell shape (2), distributed in the axial direction of the machine forming two sets of helioides (3 and 3), prepared reserved with respect to the center of the cylinder (4), in order to cut the straw, pull it toward the center of the cylinder (1) and feed the rotor homogeneously.

### TECHNOLOGY SECTOR OF INVENTION

This invention belongs, generally, to the technological sector of agricultural machines and implements and refers more specifically to a new concept applied to a grain beater accelerator cylinder, especially designed to improve the performance of axial harvesters, in particular in the harvesting of crops with a large amount of green mass and a large amount of straw. The invention also aims to provide better grain quality in special crop with low moisture content (in this case soy, seeds and/or beans), as well as reduce fuel consumption on the harvester.

### STATE OF THE KNOWN TECHNICS

The harvesters of axial rotors are machines in which the flow of tracked materials follows along the track cylinder (axial), which is mounted along the body of the machine. As the supply is made by the previous part, the drive is done by the later party. The supply system of the cutting platform is carried out with chains and sleepers, and in some models can be a transverse feeder cylinder, with helical conveyors in the external part to homogenize the supply of master cylinder. In all the models, the axial cylinder performs the operation of trail in the upper part (about ⅓) and the rest is made the separation of grain and straw. The cleaning system is made by air and sieves systems. Examples of patents of this type of equipment: a) MU6801081) that describes a cereals harvester with cylinder beater; b) MU8602523 which describes a provision in cylindrical beater to harvester.

It is also mentions that companies such as John Deere, MF, and Valtra make use of accelerator or beater cylinder mounted in axial machines. The John Deere accelerator cylinder is fitted with a series of straight blades radially arranged, i.e., transversely mounted, while others feature a series of paddles also straight, but inclined. Both conceptions have problem of grains breakage in special crops (with low moisture content). In the case of inclined paddles to the longitudinal direction, it should be noted that this inclination is at the limit, any increase in the angle will cause the loss of power efficiency to the rotor, as well as the recirculation of this material around the cylinder. It is possible to soften the material losses that occur in crops with low moisture content, through the reduction of the cylinder speed. For both, John Deere equipment are provided with a RPM variator, while other equipment performs the rotation reduction through the replacement of pulleys. The efficiency of this procedure has limits, if the percentage of moisture in the material is very extensive, this change will not have the desired effect. It should also be emphasized that the reduction of the RPM cylinder eases the breakage issue in special collection (low moisture content), but compromises the performance of the machine in green mass.

### NEWS AND OBJECTIVES OF THE INVENTION

This invention is designed to solve the problems and inconveniences of the technique status, since in the proposed solution it is possible to work with an intermediate fixed speed, without the need to use or replace variator the pulleys, in addition to the machine working well, in both green mass (without losing performance) as well as in special crop (without damaging the grain).

The new design revealed in this descriptive report adopts a new format for the paddle, which is a form of shell, i.e., there is a curvature with appropriate radius, which allows a better provision in the cylinder volume, with the paddles helically mounted, defining fighting that start from left to right (up to half) and fighting that start from left to right (up to half). The great advantage of the proposal is that it allows the paddles are mounted in the longitudinal direction of the machine, since the material will be accumulated in the curvature of the same and will be thrown to the rotor in the center. The fact that the rotor receives more evenly and centralized material mode causes the machine has level of demand for constant load on the engine, this contributes to harvest with constant speeds and with the reduction of fuel consumption.

### DESCRIPTION OF ATTACHED DRAWINGS

The purpose of this invention is fully understood and put into practice by any technician of this technological sector, it will be explained in detail, in a clear, concise and sufficient to allow its reproduction, taking as a basis the attached drawings, which are only used as an example of a possible implementation of the proposed concept, listed below:

FIG. 1 drawing in front of the cylinder, in which we see the shape curve of the paddles and the distribution of the same cylinder, as well as the direction of turning the assembly, the height and direction of material entrance.

### DETAILED DESCRIPTION OF THE INVENTION

This invention refers to a cylinder (1) grain beater accelerator cylinder to harvesters, provided with multiple paddles, in each paddle has a shell shape (2), being distributed in the axial direction of the machine forming two sets of helioides (3 and 3), prepared reserved with respect to the center of the cylinder (4), in order to cut the straw, pull it toward the center of the cylinder (1) and feed the rotor homogeneously.

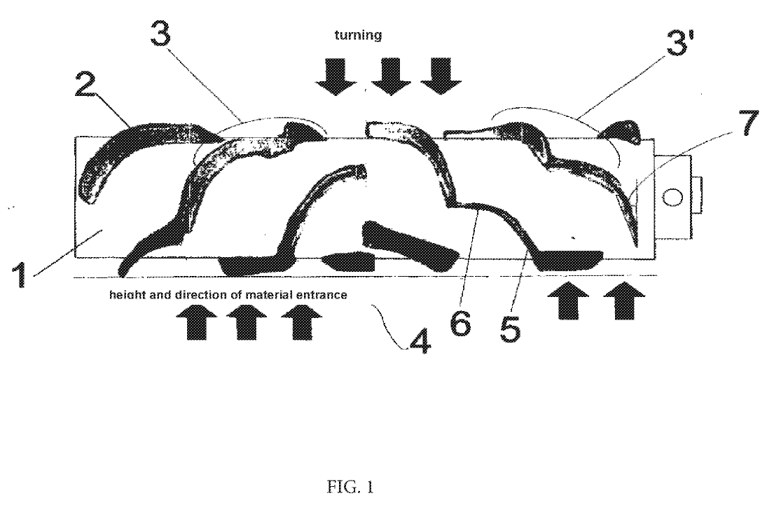

The paddle in the form of a shell (2) is made of a straight portion (5) and a curved portion (6), the latter being endowed with curvature radius suitable to cause the accumulation of material in the mentioned portion (6), acting as a shield, avoiding impacts and damage to the grain, mainly in special crops, such as soybeans, seeds or beans. In the preferred implementation represented in FIG. 1, the straight part (5) is prepared with a preferred angle (7) of 20° to the vertical. It is important to emphasize that this angle is considered the best by the inventor, but it is clear that other angles can be adopted and provide satisfactory results.

The preferred implementation provides that the helioides (3 and 3′) have three entries starting from left to right until the half and three entries from right to left until the half. It will be obvious to a technician in the subject that the number of inputs can be varied and still be within the scope of the invention as claimed.

In another invention implementation, the paddles (2) may be composed of more than one piece, which together form the same angles that the paddle (2) one piece. It was in this descriptive report a new concept applied to a grain beater accelerator cylinder to harvesters, coated with industrial application, absolute news and inventive activity, all the requirements determined by the law of industrial property to receive the pleaded privilege.

1- GRAIN BEATER ACCELERATOR CYLINDER TO HARVESTERS provided with multiple paddles, in each paddle has a shell shape (2), being distributed in the axial direction of the machine forming two sets of helioides (3 and 3), prepared reserved with respect to the center of the cylinder (4).

2- GRAIN BEATER ACCELERATOR CYLINDER TO HARVESTERS as claimed in 1 and still characterized by each paddle in the form of a shell (2) is made of a shell (2) to be composed by a straight portion (5) and a curved portion (6), being the last one endowed of proper curvature radios to impact the material accumulation in the mentioned portion (6).

3- GRAIN BEATER ACCELERATOR CYLINDER TO HARVESTERS as claimed in 2 and further characterized for the straight part (5) is prepared with a preferred angle (7) of 20° to the vertical.

4- GRAIN BEATER ACCELERATOR CYLINDER TO HARVESTERS as claimed in 1 and still characterized by helioides (3 and 3′) have three entries starting from left to right until the half and three entries from right to left until the half

5- GRAIN BEATER ACCELERATOR CYLINDER TO HARVESTERS as claimed in 1 and still characterized by paddles (2) may be composed of more than one piece, which together form the same angles that the paddle (2) one piece.
